(19) United States
(12) Patent Application Publication
(10) Pub. No.: US 2026/0159339 A1
(43) Pub. Date: Jun. 11, 2026

(54) AIR CART WITH AUXILIARY CONTAINER COUPLED TO MULTIPLE DISTRIBUTION TUBES

(71) Applicant: Bourgault Industries Ltd., St. Brieux (CA)

(72) Inventors: Scott Gerbrandt, St. Brieux (CA); Scot Jagow, St. Brieux (CA)

(21) Appl. No.: 19/351,842

(22) Filed: Oct. 7, 2025

Related U.S. Application Data
(60) Provisional application No. 63/728,814, filed on Dec. 6, 2024.

(51) Int. Cl. B65G 53/66; A01C 7/08

(52) U.S. Cl. CPC B65G 53/66; A01C 7/084

(57) ABSTRACT

An air cart apparatus includes a primary container assembly having a first container and a second container mounted to a frame. An auxiliary container is mounted to a side of the primary container assembly. A plurality of distribution tubes extend along the frame and laterally inward of the auxiliary container, for pneumatically conveying product from the primary container assembly and the auxiliary container to an agricultural implement. First, second, and third metering assemblies are positioned along the distribution tubes for metering product to the tubes from the first, second, and auxiliary containers, respectively. A feed device conveys product laterally inward from the auxiliary container to the third metering assembly.

### FIELD

The teaching disclosed herein relates to systems for distributing agricultural products, such as seed, fertilizer, etc. to a field, and more particularly, to air carts for such a system having an auxiliary container mounted aside a primary container assembly.

### INTRODUCTION

U.S. Pat. No. 9,872,427 (Thompson) purports to disclose an air cart system that includes a container assembly mounted on wheels and including a primary product container and an air distribution network including a product conduit that delivers a first agricultural product and a second agricultural product to an agricultural implement. The air cart system includes a first metering device to meter the first agricultural product from the primary product container to the product conduit. A fill hopper mounts on a side of the container assembly, and a secondary product container mounts beneath a portion of the primary product container. The secondary product container receives the second agricultural product from the fill hopper, which receives the second agricultural product at an opening and conveys the second agricultural product to the secondary product container. The air cart system includes a second metering device to meter the second agricultural product from the secondary product container to the product conduit.

Canadian Pat. No. 2,755,585C (Cresswell) purports to disclose an air seeder cart apparatus having a primary container assembly with a plurality of primary product containers, with primary fill hatches at tops thereof. An air distribution network comprises product conduits and primary metering devices that dispense agricultural products from each primary product container into one of the product conduits. A secondary product container is mounted on a side of the primary container assembly and has a secondary fill hatch much lower than the primary fill hatches, and a secondary metering mechanism dispenses product from the secondary product container into one of the product conduits. The secondary product container is convenient for receiving bagged agricultural products from a low truck bed. Unopened product bags may be stored on a gate inside the secondary product container so they will be available if required. Weighing of product in the container can be provided.

### SUMMARY

The following summary is intended to introduce the reader to various aspects of the applicant's teaching, but not to define any invention.

According to some aspects of the teaching disclosed herein, an air cart apparatus for an agricultural product dispensing system includes a primary container assembly extending longitudinally along a frame, the primary container assembly including at least a first container and a second container. An auxiliary container is mounted to a side of the primary container assembly. A plurality of distribution tubes extend longitudinally along the frame between the first and second containers and disposed laterally inward of the auxiliary container for pneumatically conveying product from the primary container assembly to an agricultural implement, the distribution tubes arranged in a side-by-side arrangement across a tube assembly width. A first metering assembly includes a first transfer chamber adjacent a first lower end of the first container and a plurality of first metering devices in communication with the first transfer chamber. Each of the first metering devices is coupled to at least one of the plurality of distribution tubes, wherein the first metering assembly delivers product from the first transfer chamber in metered amounts to the distribution tubes. A second metering assembly includes a second transfer chamber adjacent a second lower end of the second container and a plurality of second metering devices in communication with the second transfer chamber. Each of the second metering devices is coupled to at least one of the plurality of distribution tubes, wherein the second metering assembly delivers product from the second transfer chamber in metered amounts to the distribution tubes. An auxiliary container is mounted to a side of the primary container assembly. A third metering assembly including a third transfer chamber is positioned longitudinally between the first and second transfer chambers, and a plurality of third metering devices of the third metering assembly are in communication with the third transfer chamber. Each of the third metering devices is coupled to at least one of the plurality of distribution tubes, wherein the third metering assembly delivers product from the third transfer chamber in metered amounts to the distribution tubes. A feed device is provided for conveying product laterally inward from the auxiliary container to the third transfer chamber.

According to some embodiments, the tube assembly width straddles a longitudinal centerline of the container assembly.

According to some embodiments, the tube assembly width is centered along the longitudinal centerline.

According to some embodiments, the tube assembly width is at least 40 cm.

According to some embodiments, the feed device comprises a gravity feed chute having an inlet and an outlet, the inlet in communication with the auxiliary container, the outlet in communication with the third transfer chamber, and the inlet disposed at a higher elevation than the outlet.

According to some embodiments, the feed device comprises an enclosed conveyor having a conveyor inlet in communication with the auxiliary container.

According to some embodiments, the conveyor comprises at least one of a screw conveyor, or a drag conveyor.

According to some embodiments, the feed device comprises a buffer reservoir downstream of the auxiliary container and upstream of the third transfer chamber.

According to some embodiments, the feed device comprises a pneumatic feed tube for transferring product from the auxiliary container to a buffer reservoir, the buffer reservoir transferring product to the third transfer chamber at a rate sufficient to maintain a minimum fill level of the third transfer chamber.

According to some embodiments, the buffer reservoir comprises at least one pneumatic exhaust port at a selected fill level, wherein when product in the buffer reservoir reaches the fill level, the at least one pneumatic exhaust port is obstructed so that airflow through the pneumatic feed tube is reduced and entrainment of the product is stopped.

According to some embodiments, the buffer reservoir comprises a housing disposed above the third transfer chamber and between the first and second containers. In some embodiments, the housing is in the form of an upright cylinder.

In some embodiments, the third transfer chamber is disposed longitudinally between the first and second transfer chambers.

In some embodiments, the third metering assembly is disposed longitudinally between the first and second containers.

According to some embodiments, the first, second, and third metering assemblies are identical.

According to some embodiments, each of the first, second, and third metering devices comprises an inclined auger.

According to some embodiments, the plurality of distribution tubes includes a quantity of upper tubes spaced laterally apart in an upper layer and a quantity of lower tubes spaced laterally apart in a lower layer disposed beneath the upper layer. In some embodiments, the quantity of upper tubes is in the range of 5 to 12. In some embodiments, the quantity of lower tubes is in the range of 5 to 12. In some embodiments, the quantity of upper tubes is equal to the quantity of lower tubes.

### DRAWINGS

For a better understanding of the described examples and to show more clearly how they may be carried into effect, reference will now be made, by way of example, to the accompanying drawings in which:

FIG. 1A is an elevation view of an example air cart apparatus according to aspects of the teaching disclosed herein, shown coupled to an agricultural implement and a tractor;

FIG. 1B is an enlarged perspective view of a portion of the air cart of FIG. 1A;

FIG. 2 is a schematic perspective view of portions of the apparatus of FIG. 1A;

FIG. 3 is a top view of the apparatus of FIG. 2;

FIG. 4 is a cross-sectional view of the apparatus of FIG. 3, taken along the line 4-4;

FIG. 5 is a top view of portions of an air cart apparatus according to another embodiment;

FIG. 6 is a side elevation view of the apparatus of FIG. 5;

FIG. 7 is a cross-sectional view of the apparatus of FIG. 6, taken along the line 7-7;

FIG. 8 is a side elevation view of portions of an air cart according to another embodiment; and

FIG. 9 is a cross-sectional view of the apparatus of FIG. 8, taken along the line 9-9.

The drawings included herewith are for illustrating various examples of apparatuses and methods of the teaching of the present specification and are not intended to limit the scope of what is taught in any way.

### DESCRIPTION

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

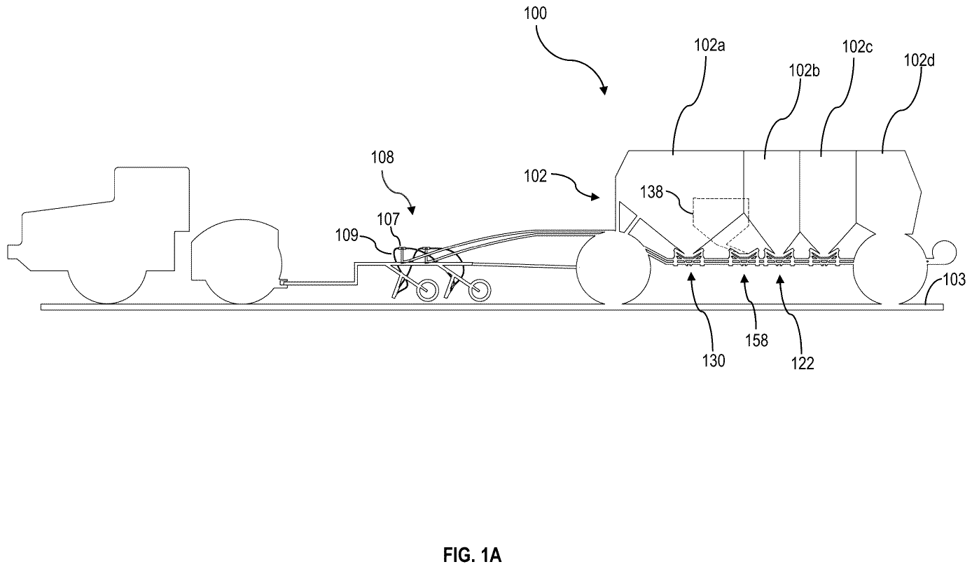

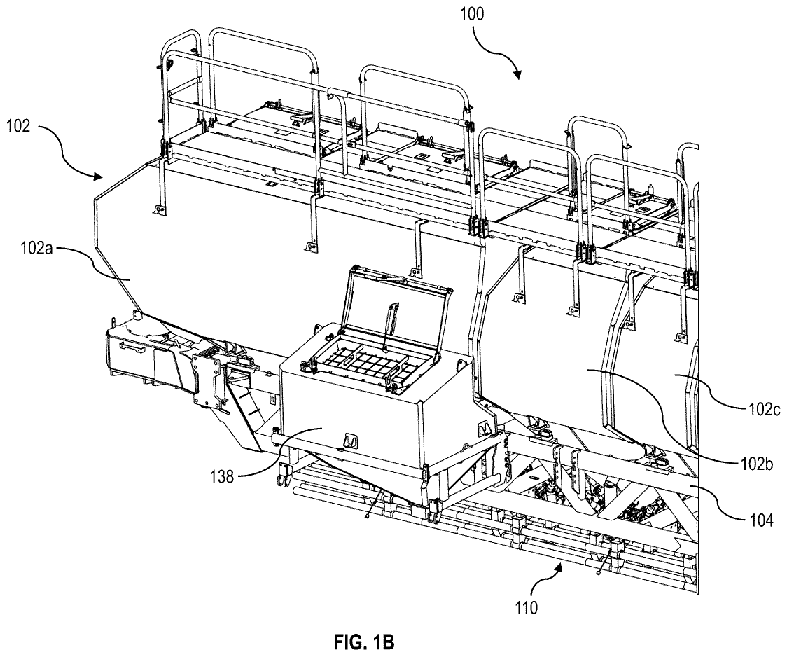

With reference to FIGS. 1A and 1B, an air cart apparatus 100 comprises a primary container assembly 102, for storing product to be applied to a field (e.g. ground surface 103). In the example illustrated, the primary container assembly 102 is supported by a frame 104, and extends along a longitudinal axis 106.

The primary container assembly 102 includes multiple containers arranged along a length of the container assembly 102. Each container can hold a volume of product separately from any adjacent container. In the example illustrated, the primary container assembly includes four containers 102a, 102b, 102c, and 102d arranged in a row from a front end of the air cart apparatus 100 to a rear end of the air cart apparatus 100. Any two adjacent ones of the multiple containers can be designated as a first container and a second container. In the example illustrated, the container 102b is designated as the first container 102b, and the container 102a is designated as the second container 102a.

Each of the first container 102b and the second container 102a comprise, in the example illustrated, an enclosed space bounded by side walls, end walls, and a top wall. The walls are, in the example illustrated, constructed from a metal material. Product for distribution by the apparatus 100 is contained within the first container 102b and second container 102a. Different product may be stored in each container 102a, 102b, such that the apparatus 100 may distribute two different products in a single pass or operation. For example, a first product in the form of fertilizer may be provided in the first container 102b, and a second product in the form of seed may be provided in the second container 102a. In some cases, the same product may be provided in the first and second containers, for example, where the volume of a product desired to be loaded in the primary container assembly 102 exceeds the capacity of one of the containers.

In other examples, the arrangement and construction of the primary container assembly 102 may differ. For example, the primary container assembly may comprise more or fewer than four containers, and may have containers of different shapes and/or materials (e.g. polymer construction).

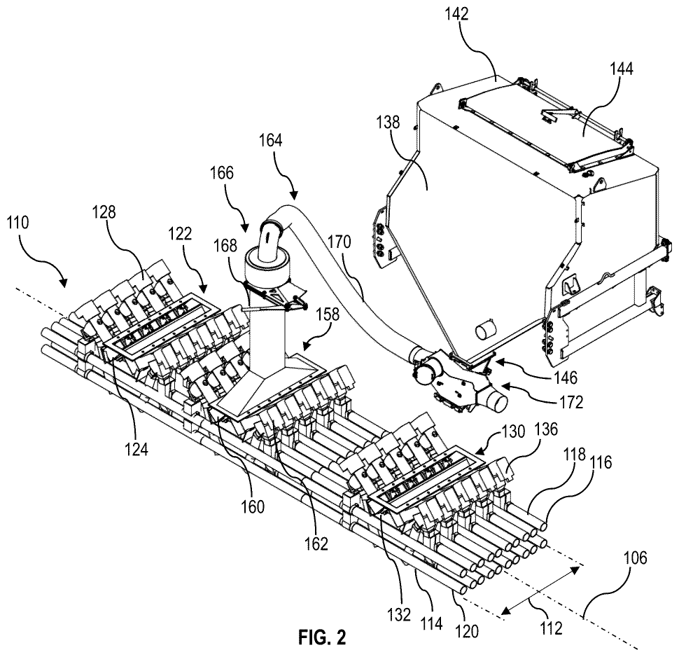

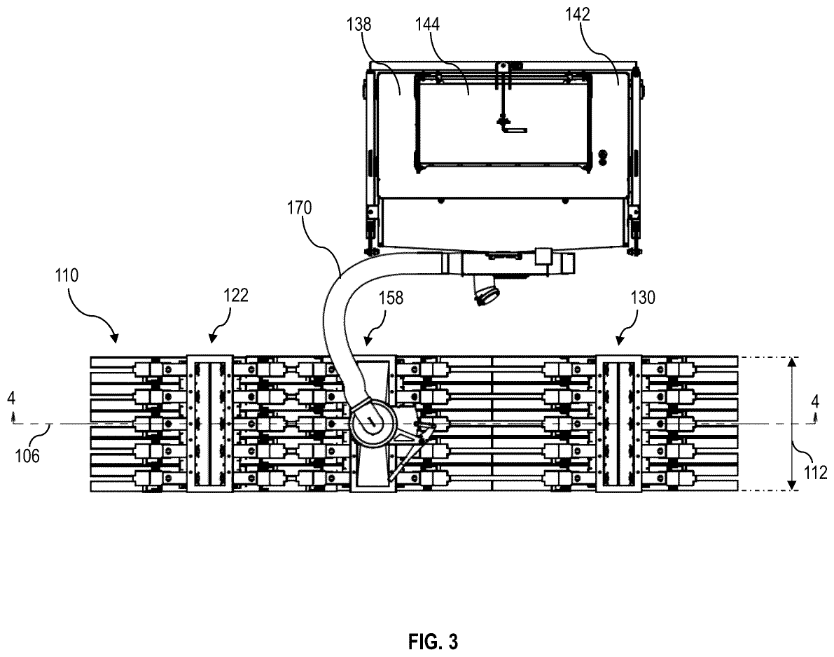

With reference to FIGS. 2 and 3, the apparatus 100 further comprises a plurality of distribution tubes 110 extending along the frame and, in the example illustrated, longitudinally between the first container 102b and the second container 102a. The distribution tubes 110 are arranged in a tube assembly and are configured for pneumatically conveying product from the air cart apparatus 100 to an agricultural implement 108 (FIG. 1A). In the example illustrated, the plurality of distribution tubes 110 extend longitudinally between all of the containers of the primary container assembly 102, enabling the tubes 110 to receive product from any one or more of the containers 102a, 102b, 102c, 102d of the primary container assembly 102. Furthermore, in the example illustrated, the distribution tubes 110 are disposed laterally inward of an auxiliary container 138 mounted to a side of the primary container assembly (described in greater detail hereinafter).

In the example illustrated, the quantity and arrangement of the distribution tubes 110 is advantageously configured to facilitate operating the air cart apparatus 100 in what is commonly referred to as a “Class B” or “Type B” distribution mode. More particularly, in some examples, the plurality of distribution tubes 110 (i.e. of the tube assembly) includes at least five distribution tubes 110 arranged in a lateral side-by-side configuration, with each distribution tube 110 extending from a meter on the air cart to a header 107 on the implement 108. In some examples, the plurality of distribution tubes includes up to 12 distribution tubes arranged in a lateral side-by-side arrangement. In the example illustrated, the plurality of distribution tubes 110 includes ten distribution tubes arranged in a lateral side-by-side arrangement (i.e. ten runs). A plurality of secondary lines 109 extend from each header 107 to discharge boots mounted to openers fixed to the implement 108. In the example illustrated, each header 107 is coupled to a plurality of discharge boots arranged in a respective section of the implement to facilitate sectional control of the product distribution.

Furthermore, in some examples, the plurality of distribution tubes 110 are configured to facilitate multi-shoot operation of the air cart apparatus 100. In some examples, the plurality of distribution tubes are arranged in two layers to facilitate double-shoot operation, or in three layers to facilitate triple-shoot operation. In the example illustrated, the plurality of distribution tubes 110 are arranged in two layers, comprising an upper layer and a lower layer positioned vertically beneath the upper layer. In the example illustrated, the quantity of tubes 110 in each layer is equal, namely, ten tubes 110 in each layer for a total of twenty distribution tubes 110. Furthermore, in the example illustrated, each one of the tubes 110 in the upper layer is vertically aligned with a respective one of the tubes 110 in the lower layer. In the example illustrated, the side-by-side arrangement of the distribution tubes 110 extends laterally across a tube assembly width 112. More particularly, the tube assembly width 112 is defined by a lateral distance between respective outward facing surfaces of a left-most one of the distribution tubes 110 and right-most one of the distribution tubes 110 in the arrangement of the plurality of distribution tubes 110. The tube assembly width increases with the number of tubes arranged in side-by-side relation (i.e. the number of runs of the distribution system). In some examples, the tube assembly width is at least about 8 cm per run, and in some examples, the tube assembly width is at least 10 cm per run. In some examples, the tube assembly width is at least 40 cm. In the example illustrated, the tube assembly width 112 is about 80 cm.

In some examples, the tube assembly width straddles the longitudinal axis 106 of the apparatus 100. In the example illustrated, the tube assembly width 112 is centered about the longitudinal axis 106 of the apparatus 100.

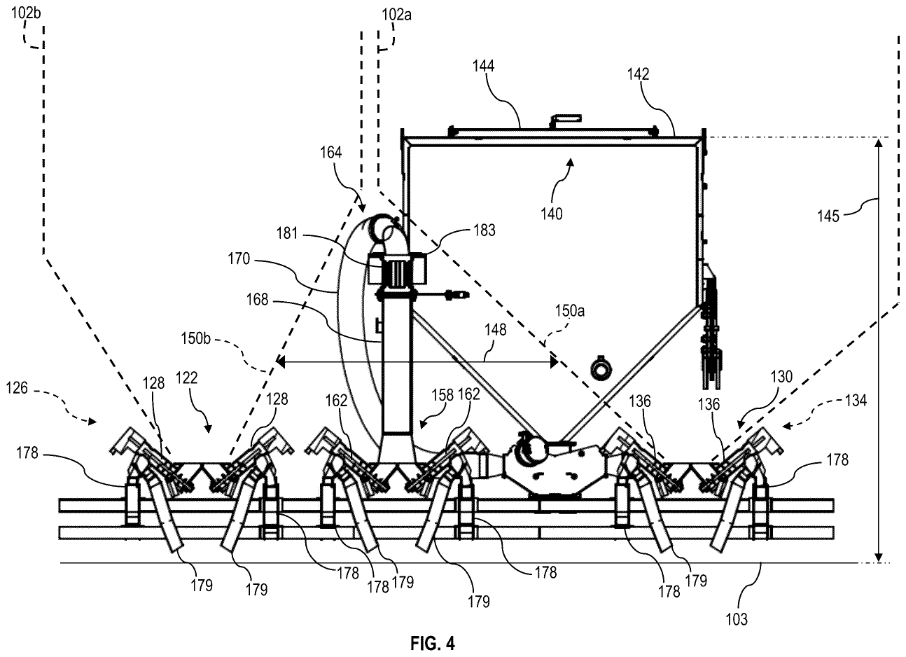

With reference to FIGS. 2 and 4, the apparatus 100 further comprises a first metering assembly 122 that includes a first transfer chamber 124 adjacent a first lower end 126 of the first container 102b and a plurality of first metering devices 128 in communication with the first transfer chamber 124. In the example illustrated, the first transfer chamber 124 is disposed between the first lower end 126 and the distribution tubes 110. Each of the first metering devices 128 is coupled to at least one of the plurality of distribution tubes 110. In operation of the apparatus 100, the first transfer chamber 124 receives product from the first container 102b, and the first metering assembly 122 delivers product from the first transfer chamber 124 in metered amounts to the distribution tubes 110.

The apparatus 100 further comprises a second metering assembly 130 that includes a second transfer chamber 132 adjacent a second lower end 134 of the second container 102a and a plurality of second metering devices 136 in communication with the second transfer chamber 132. Each of the second metering devices 136 is coupled to at least one of the plurality of distribution tubes 110. In operation, the second transfer chamber receives product from the second container 102a, and the second metering assembly 130 delivers product from the second transfer chamber 132 in metered amounts to the distribution tubes 110.

The apparatus 100 further comprises an auxiliary container 138 mounted to a side of the primary container assembly 102. The auxiliary container 138 is sized and positioned to facilitate manual loading of product to be dispensed by the air cart apparatus 100. In particular, in the example illustrated, the auxiliary container 138 has a fill opening 140 in a top wall 142 of the auxiliary container 138 that is positioned at a height 145 above the ground surface 103 (FIG. 4) that is much lower than the height of the fill openings of the containers of the primary container assembly 102. This lower height of the fill opening 140 can facilitate, for example, manually emptying bags of product into the auxiliary container 138. Positioning the auxiliary container 138 on the side of the primary container assembly can also provide easier access to the auxiliary container 138 and the fill opening 140, via, for example, the bed of a pick-up truck, and/or via steps and a platform mounted to the air cart apparatus 100 proximate the auxiliary container 138. In FIG. 4, the fill opening 140 is shown covered by an openable hatch 144.

The inventors have found that positioning the auxiliary container 138 to the side of the primary container assembly 102 can present some challenges, particularly in relation to feeding product from the auxiliary container 138 to the distribution tubes 110 across the tube assembly width 112 with a desired degree of efficiency and accuracy. The inventors overcame these challenges by providing, in some examples, a third metering assembly and a feed device, as described in greater detail below.

Referring again to FIG. 2, in the example illustrated, the apparatus 100 further comprises a third metering assembly 158. The third metering assembly 158 comprises a third transfer chamber 160 positioned longitudinally between the first transfer chamber 124 and the second transfer chamber 132. The third metering assembly 158 is positioned laterally inward from the auxiliary container 138, and is, in the example illustrated, generally centered over the tube assembly width 112. Furthermore, in the example illustrated, the first metering assembly 122, second metering assembly 130, and third metering assembly 158 are centered about the longitudinal axis 106.

The third metering assembly 158 further comprises a plurality of third metering devices 162 in communication with the third transfer chamber 160. Each of the third metering devices 162 is coupled to at least one of the plurality of distribution tubes 110. In operation, the third transfer chamber 160 receives product from the auxiliary container 138, and the third metering assembly 158 delivers product from the third transfer chamber 160 in metered amounts to the distribution tubes 110.

In the example illustrated, the first metering assembly 122, second metering assembly 130, and third metering assembly 158 are identical, having the same general dimensions, construction and functionality. This common metering assembly configuration can facilitate providing equivalent accuracy in product dispensed from the auxiliary container 138 as from the containers of the primary container assembly 102. Furthermore, the common metering assembly configuration can help to provide an apparatus that responds to external factors uniformly, which can promote uniform application of product from each of the primary containers 102a-d and the auxiliary container 138.

The metering assemblies 122, 130, 158 and distribution tubes 110 are, in the example illustrated, configured to feed product to the discharge boots at the openers via a single split at the headers 107 on the implement 108. More particularly, each distribution tube 110 is configured to convey product from a respective metering device to a respective header 107 at a sufficient flow rate to feed the plurality of discharge boots connected to the header via the secondary lines 109. In the example illustrated, the number of discharge boots coupled to each header 107 is in the range of seven to twelve.

In the example illustrated, the third metering assembly 158 is advantageously disposed in a gap 148 between opposed outer surfaces of the front sidewall 150b of the first container 102b and the back sidewall 150a of the second container 102a (FIG. 4). More particularly, in the example illustrated, lower portions of the back and front sidewalls 150b, 150a are inclined away from each other with decreasing elevation, to facilitate funneling product in the first and second containers towards respective discharge outlets at lower ends thereof. The inclined walls contribute to creation of the gap 148 between the first and second containers 102b, 102a and above the distribution tubes 110.

The apparatus 100 further comprises a feed device 164 for conveying product laterally inward from the auxiliary container 138 to the third transfer chamber 160. In the example illustrated, the feed device 164 conveys product from a discharge outlet 146 of the auxiliary container 138 (e.g. FIG. 2), laterally inward for delivery to the third metering assembly 158.

In the example illustrated, the feed device 164 comprises a feed tube 170 and an induction manifold 172 for pneumatically transferring product from the auxiliary container 138 to the third metering assembly 158. The induction manifold 172 includes an internal chamber in communication with a product inlet that is coupled to the discharge outlet 146 of the auxiliary tank 138. The induction manifold further includes an airflow inlet coupled to a source of pressurized air, and an airflow outlet, with the internal chamber disposed between the airflow inlet and the airflow outlet. The feed tube 170 has an upstream end coupled to the airflow outlet of the induction manifold 172. In operation, product from the auxiliary tank 138 is entrained in an airflow travelling from the airflow inlet to the airflow outlet and into the feed tube 170.

The feed device 164 further includes, in the example illustrated, a buffer reservoir 166 disposed downstream of the auxiliary container 138 and upstream of the third transfer chamber 160. The buffer reservoir is, in the example illustrated, configured to contain an amount of product for direct delivery to the third transfer chamber via gravitational force. The buffer reservoir 166 can help avoid starvation of product to the third transfer chamber 160. In some respects, the buffer reservoir 166 serves as a proxy for the lower ends of the respective containers disposed immediately above the first transfer chamber and the second transfer chamber, and can further facilitate operational uniformity of the third metering assembly in comparison to the first and second metering assemblies.

In the example illustrated, the buffer reservoir 166 comprises a housing 168 disposed directly above the third transfer chamber 160. The buffer reservoir housing 168 is, in the example illustrated, provided in the gap 148 between the first and second containers of the primary container assembly 102. In the example illustrated, the housing 168 is in the form of an upright cylinder. A downstream end of the feed tube 170 is coupled to an inlet of the buffer reservoir 166 for receiving product from the auxiliary container 138. Product within the buffer reservoir 166 is, in the example illustrated, fed directly downward into the third transfer chamber 160 by gravity.

Referring again to FIG. 4, the buffer reservoir 166 further includes at least one optional pneumatic exhaust port 181. In the example illustrated, the buffer reservoir includes a plurality of the exhaust ports 181. Each of the at least one exhaust ports 181 is provided in a sidewall of the housing 168 at a selected fill level 183 along a height of the buffer reservoir. When an upper surface of the volume of product in the buffer reservoir is below the fill level, the exhaust ports 181 are open and the airflow conveying product into the buffer reservoir through the feed tube is unimpeded. However, when product in the buffer reservoir 166 reaches the fill level 183, the pneumatic exhaust ports 181 are obstructed by the product such that airflow through the pneumatic feed tube 170 is reduced. When the airflow through the feed tube 170 is reduced, product is no longer entrained in the airflow, and therefore product is no longer pneumatically conveyed from the auxiliary container 138 to the buffer reservoir. This arrangement provides automatic control for conveying product to the buffer reservoir only when needed (when below the fill level 183).

In other examples, the feed device may include a different arrangement for controlling filling of the buffer reservoir. For example, the feed device may include an electronic control system including a fill level sensor for providing feedback to the control system to modulate pneumatic flow.

In the example illustrated, the first metering devices 128, second metering devices 136, and third metering devices 162 are each provided in the form of an inclined auger. Each inclined auger, in the example illustrated, conveys product from a respective one of the transfer chambers 124, 132, 160 to the distribution tubes 110 of a respective run through a transfer manifold 178. Product can also be diverted to a discharge tube 179 for meter calibration and/or emptying of each respective container and/or transfer chamber.

In other examples, each metering device 128, 136, 162 may comprise a metering mechanism other than an auger for conveying metered amounts of product from the transfer chambers to the distribution tubes. Such other metering mechanisms may comprise, for example, a rotary member such as a metering roller.

In operation, the auxiliary container 138 is loaded with an auxiliary product, through the opening 140 of the auxiliary container 138. Additionally, a first product and a second product are each loaded into the first container 102b and second container 102a respectively. The auxiliary product, first product, and second product may comprise the same products or different products depending on operational requirements.

The first product and second product are conveyed by gravity into the first transfer chamber 124 and second transfer chamber 132, respectively, through respective discharge outlets in the first container first lower end 126 and the second container second lower end 134, respectively.

The auxiliary product is conveyed from the auxiliary container 138 to the feed device 164, through the outlet 146 of the auxiliary container 138 via gravity. Once auxiliary product is entrained in the airflow through the induction manifold 172, the feed tube 170 of the feed device 164 pneumatically conveys the auxiliary product laterally toward the longitudinal axis 106 of the apparatus 100 and into the buffer reservoir 166.

From the buffer reservoir 166, the auxiliary product is urged into the third transfer chamber 160 by gravitational force, where it is engaged by the third metering devices 162 for delivery in metered amounts to the distribution tubes 110.

Similarly, the first product and second product are conveyed in metered amounts from the first and second transfer chambers 124, 132 into respective ones of the plurality of distribution tubes 110 by the first and second metering devices 128, 136, respectively.

Once within the distribution tubes 110, the first product, second product and auxiliary product are pneumatically conveyed through the distribution tubes 110 to the agricultural implement 108, for application to the ground surface of a field.

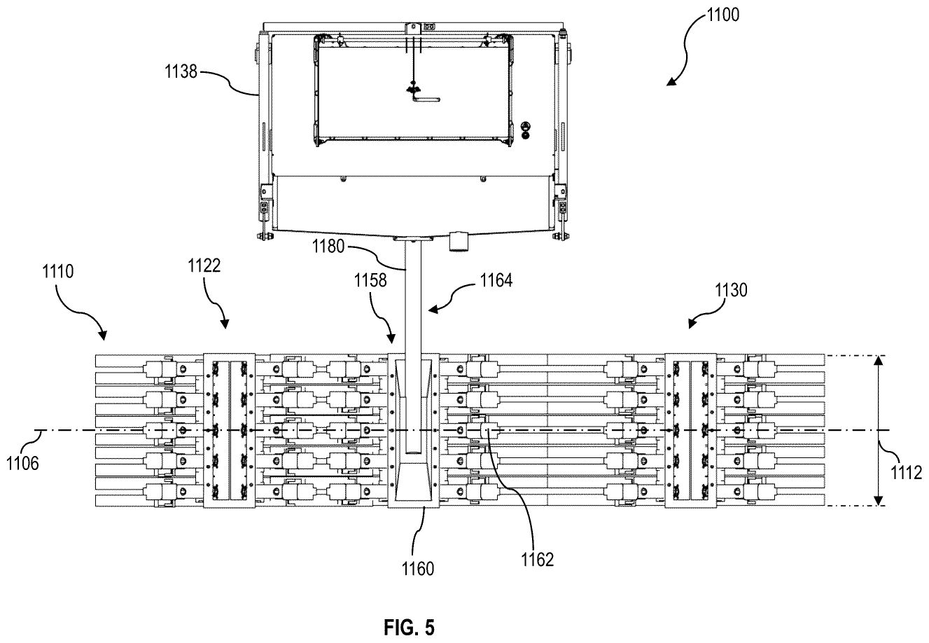

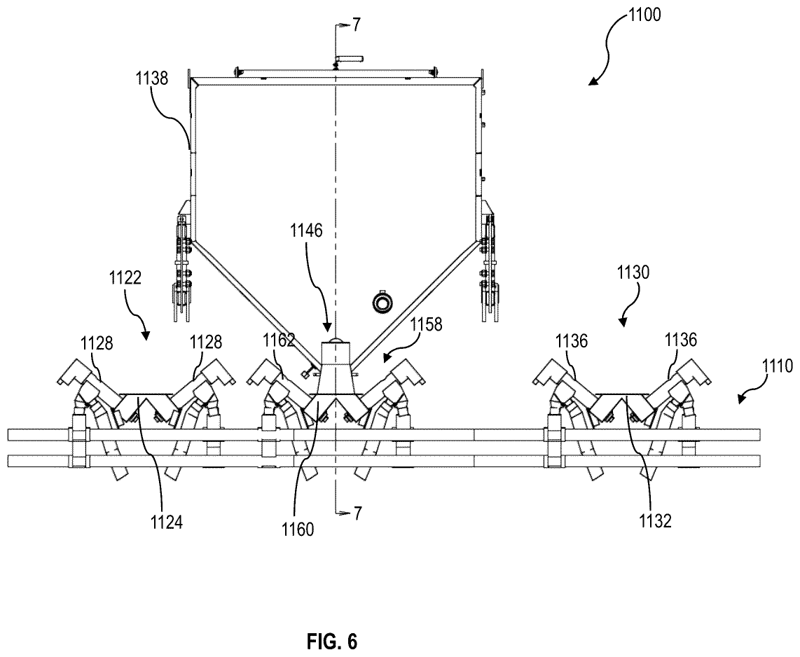

With reference to FIGS. 5 to 7, an air cart apparatus 1100 according to another embodiment is similar to the air cart apparatus 100, and like features are identified with like reference characters, incremented by 1000.

The air cart apparatus 1100 includes a primary container assembly having at least first and second containers (not shown) for holding agricultural product, an auxiliary container 1138 mounted to a side of the primary container assembly, and a plurality of distribution tubes 1110 extending longitudinally between the first and second containers for pneumatically conveying product from the air cart apparatus 1100 to an agricultural implement (such as implement 108 of FIG. 1A).

The apparatus 1100 further includes, in the example illustrated, a first metering assembly 1122 having a first transfer chamber 1124 and a plurality of first metering devices 1128 in communication with the first transfer chamber 1124. Each of the first metering devices 1128 is coupled to at least one of the plurality of distribution tubes 1110. In operation, the first transfer chamber 1124 receives product from the first container, and the first metering assembly 1122 delivers product from the first transfer chamber 1124 in metered amounts to the distribution tubes 1110.

The apparatus 1100 further includes, in the example illustrated, a second metering assembly 1130 that includes a second transfer chamber 1132 and a plurality of second metering devices 1136 in communication with the second transfer chamber 1132. Each of the second metering devices 1136 is coupled to at least one of the plurality of distribution tubes 1110. In operation, the second transfer chamber 1132 receives product from the second container, and the second metering assembly 1130 delivers product from the second transfer chamber 1132 in metered amounts to the distribution tubes 1110.

The apparatus 1100 further includes, in the example illustrated, a third metering assembly 1158. The third metering assembly 1158 has a third transfer chamber 1160 positioned longitudinally between the first transfer chamber 1124 and the second transfer chamber 1132. The third metering assembly 1158 is positioned laterally inward from the auxiliary container 1138, and is, in the example illustrated, generally centered over the tube assembly width 1112 of the tubes 1110. Furthermore, in the example illustrated, the first metering assembly 1122, second metering assembly 1130, and third metering assembly 1158 are centered about the longitudinal axis 1106.

The third metering assembly 1158 includes a plurality of third metering devices 1162 in communication with the third transfer chamber 1160. Each of the third metering devices 1162 is coupled to at least one of the plurality of distribution tubes 1110. In operation, the third transfer chamber 1160 receives product from the auxiliary container 1138, and the third metering assembly 1158 delivers product from the third transfer chamber 1160 in metered amounts to the distribution tubes 1110.

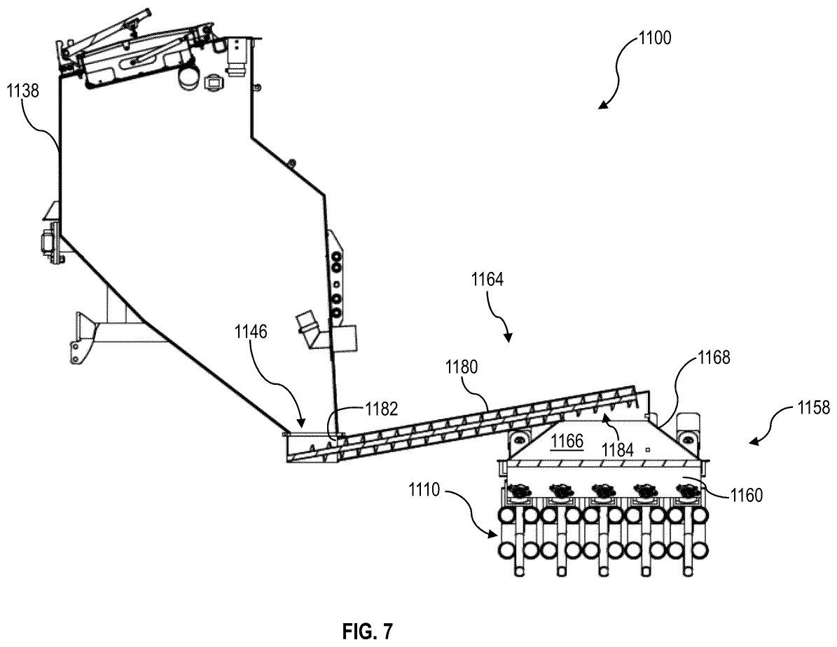

The air cart apparatus 1100 further includes a feed device 1164 for conveying product laterally inwardly from the auxiliary container 1138 to the third transfer chamber 1160. In the example illustrated, the feed device 1164 comprises a conveyor in the form of a screw conveyor 1180 configured to transport the product laterally inwardly from the auxiliary chamber 1138 (FIG. 7). The conveyor 1180, in the example illustrated, includes a conveyor screw enclosed within a housing. The housing has, in the illustrated example, a conveyor inlet 1182 coupled to a discharge outlet 1146 of the auxiliary container 1138, and a conveyor outlet 1184 downstream of the conveyor inlet and disposed above the third transfer chamber 1160.

Referring to FIG. 7, The feed device 1164 further includes, in the example illustrated, a buffer reservoir 1166 disposed downstream of the auxiliary container 1138 and upstream of the third transfer chamber 1160. The buffer reservoir is, in the example illustrated, configured to contain an amount of product for direct delivery to the third transfer chamber via gravitational force. In the example illustrated, the buffer reservoir 1166 comprises a housing 1168 disposed directly above the third transfer chamber 1160. In the example illustrated, the housing 1168 is in the form of a truncated rectangular prism. The housing 1168, in the example illustrated, covers the third transfer chamber 1160 from above.

In operation, product is conveyed from the auxiliary container outlet 1146 to the conveyor inlet 1182, for transport through the feed device 1164. The product is conveyed through the conveyor 1180 and is discharged from the conveyor 1180 via the conveyor outlet 1184. The product is then delivered to the third transfer chamber 1160 via the buffer reservoir 1166. The third metering devices 1162 of the third metering assembly 1158 then extract the product from third transfer chamber 1160 and deliver the product in metered amounts to respective ones of the plurality of distribution tubes 1110.

In the example illustrated, the conveyor 1180 comprises a screw conveyor. In other examples, the conveyor may comprise different conveyor arrangements, for example, a drag conveyor, or other conveyor.

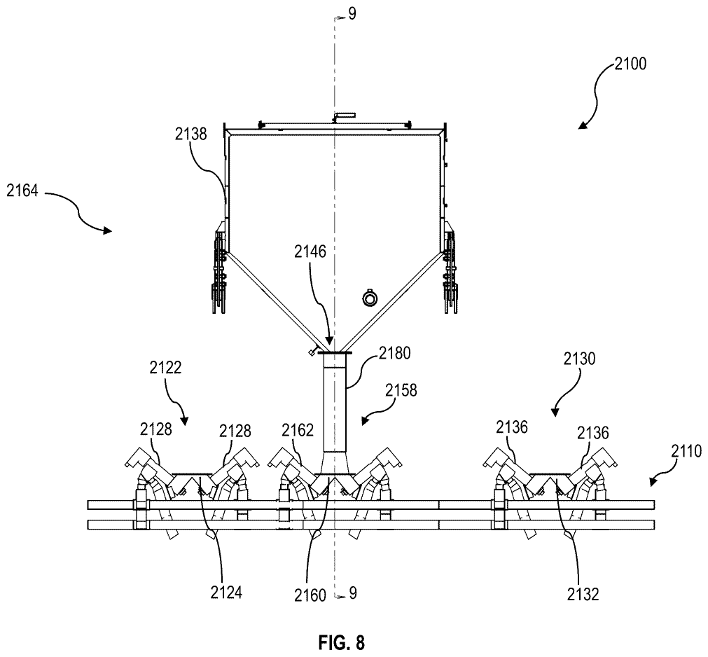

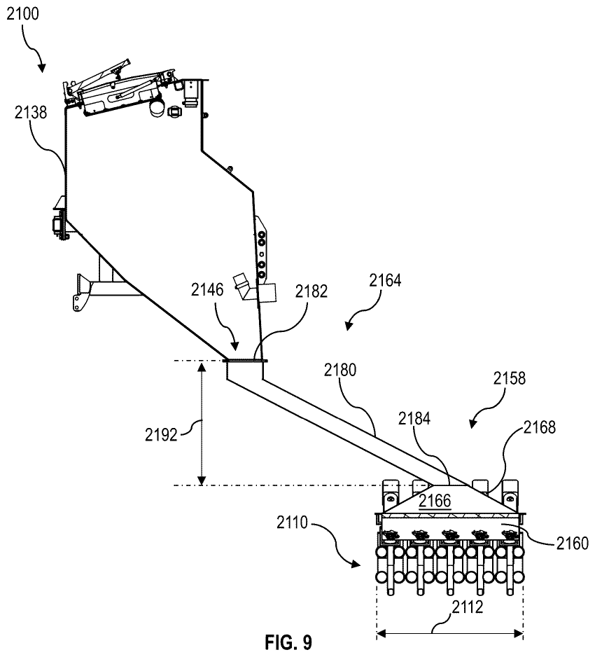

With reference to FIGS. 8 and 9, an air cart apparatus 2100 according to another embodiment is similar to the air cart apparatus 100, and like features are identified by like reference characters, incremented by 2000.

The air cart apparatus 2100 includes a primary container assembly having at least first and second containers (not shown) for holding agricultural product, an auxiliary container 2138 mounted to a side of the primary container assembly, and a plurality of distribution tubes 2110 extending longitudinally between the first and second containers for pneumatically conveying product from the air cart apparatus 2100 to an agricultural implement (such as implement 108 of FIG. 1A).

The apparatus 2100 further includes, in the example illustrated, a first metering assembly 2122 having a first transfer chamber 2124 and a plurality of first metering devices 2128 in communication with the first transfer chamber 2124. Each of the first metering devices 2128 is coupled to at least one of the plurality of distribution tubes 2110. In operation, the first transfer chamber 2124 receives product from the first container, and the first metering assembly 2122 delivers product from the first transfer chamber 2124 in metered amounts to the distribution tubes 2110.

The apparatus 2100 further includes, in the example illustrated, a second metering assembly 2130 that includes a second transfer chamber 2132 and a plurality of second metering devices 2136 in communication with the second transfer chamber 2132. Each of the second metering devices 2136 is coupled to at least one of the plurality of distribution tubes 2110. In operation, the second transfer chamber 2132 receives product from the second container, and the second metering assembly 2130 delivers product from the second transfer chamber 2132 in metered amounts to the distribution tubes 2110.

The apparatus 2100 further includes, in the example illustrated, a third metering assembly 2158. The third metering assembly 2158 has a third transfer chamber 2160 positioned along the distribution tubes 2110 and, in the example illustrated, longitudinally between the first transfer chamber 2124 and the second transfer chamber 2132. The third metering assembly 2158 is positioned laterally inward from the auxiliary container 2138, and is, in the example illustrated, generally centered over the tube assembly width 2112 of the tubes 2110 (FIG. 9). Furthermore, in the example illustrated, the first metering assembly 2122, second metering assembly 2130, and third metering assembly 2158 are centered about a longitudinal axis of the cart apparatus 2100.

The third metering assembly 2158 includes a plurality of third metering devices 2162 in communication with the third transfer chamber 2160. Each of the third metering devices 2162 is coupled to at least one of the plurality of distribution tubes 2110. In operation, the third transfer chamber 2160 receives product from the auxiliary container 2138, and the third metering assembly 2158 delivers product from the third transfer chamber 2160 in metered amounts to the distribution tubes 2110.

The air cart apparatus 2100 further includes a feed device 2164 for conveying product laterally inwardly from the auxiliary container 2138 to the third transfer chamber 2160. In the example illustrated, the feed device 2164 comprises a conveyor 2180 in the form of a gravity feed conveyor, having an inclined chute configured to transport the product laterally inwardly and downwardly from the auxiliary chamber 2138 (FIG. 9) by gravitational force. The conveyor 2180, in the example illustrated, includes a conveyor inlet 2182 coupled to a discharge outlet 2146 of the auxiliary container 2138, and a conveyor outlet 2184 downstream of the conveyor inlet 2182 and disposed above the third transfer chamber 2160. To facilitate conveyance of the product along the conveyor 2180 by gravitational force, the conveyor inlet 2182 is spaced vertically higher than the conveyor outlet 2184 by a vertical offset 2192. In some examples, the vertical offset is between 30 cm and 150 cm. In the example illustrated, the vertical offset 2192 is about 60 cm.

Referring again to FIG. 9, The feed device 2164 further includes, in the example illustrated, a buffer reservoir 2166 disposed downstream of the auxiliary container 2138 and upstream of the third transfer chamber 2160. The buffer reservoir 2166 is, in the example illustrated, configured to contain an amount of product for direct delivery downward from the buffer reservoir to the third transfer chamber 2160 via gravitational force. In the example illustrated, the buffer reservoir 2166 comprises a housing 2168 disposed directly above the third transfer chamber 1160. In the example illustrated, the housing 2168 is in the form of a truncated rectangular prism, and covers the third transfer chamber.

In operation, product is introduced from the auxiliary container outlet 2146 to the conveyor inlet 2182, for transport through the feed device 2164. The product is conveyed through the chute of the gravity conveyor 2180 and is discharged from the chute via the conveyor outlet 2184. The product is then delivered to the third transfer chamber 2160 via the buffer reservoir 2166. The third metering devices 2162 of the third metering assembly 2158 extract product from the third transfer chamber 2160 and deliver the product in metered amounts to respective ones of the plurality of distribution tubes 2110.

What has been described above is intended to be illustrative of examples of the teaching disclosed herein, without limiting the scope of any patent claims granted herefrom. The scope of such claims should be given the broadest interpretation consistent with the description as a whole.

1. An air cart apparatus for an agricultural product dispensing system, comprising:
a) a primary container assembly extending longitudinally along a frame, the primary container assembly including at least a first container and a second container;
b) an auxiliary container mounted to a side of the primary container assembly;
c) a plurality of distribution tubes extending longitudinally between the first and second containers and disposed laterally inward of the auxiliary container for pneumatically conveying product from the primary container assembly and the auxiliary container to an agricultural implement, the distribution tubes arranged in a side-by-side arrangement across a tube assembly width;
d) a first metering assembly comprising a first transfer chamber disposed between a first lower end of the first container and the plurality of distribution tubes, and a plurality of first metering devices in communication with the first transfer chamber;
e) a second metering assembly comprising a second transfer chamber disposed between a second lower end of the second container and the plurality of distribution tubes, and a plurality of second metering devices in communication with the second transfer chamber;
f) a third metering assembly comprising a third transfer chamber disposed above the plurality of distribution tubes, and a plurality of third metering devices in communication with the third transfer chamber; and
g) a feed device for conveying product laterally inward from the auxiliary container to the third transfer chamber;
wherein each of the first, second, and third metering devices is coupled to at least one of the plurality of distribution tubes for delivering product in metered amounts from the first, second, and third transfer chambers to the distribution tubes.

2. The apparatus of claim 1, wherein the tube assembly width straddles a longitudinal centerline of the container assembly.

3. The apparatus of claim 2, wherein the tube assembly width is centered along the longitudinal centerline.

4. The apparatus of claim 1, wherein the tube assembly width is at least 40 cm.

5. The apparatus claim 1, wherein the feed device comprises an enclosed conveyor having a conveyor inlet in communication with the auxiliary container.

6. The apparatus of claim 5, wherein the enclosed conveyor comprises an inclined chute having a conveyor inlet and a conveyor outlet downstream of the conveyor inlet, the conveyor inlet proximate and in communication with the auxiliary container, the conveyor outlet proximate and in communication with the third transfer chamber, and the conveyor inlet disposed at a higher elevation than the conveyor outlet to facilitate product transfer from the conveyor inlet to the conveyor outlet by gravity.

7. The apparatus of claim 5, wherein the conveyor comprises at least one of a screw conveyor or a drag conveyor.

8. The apparatus of claim 6, wherein the feed device comprises a buffer reservoir downstream of the auxiliary container and upstream of the third transfer chamber.

9. The apparatus of claim 8, wherein the buffer reservoir includes a housing disposed above the third transfer chamber.

10. The apparatus of claim 9, wherein the housing is in the form of a truncated rectangular prism covering the third transfer chamber from above.

11. The apparatus of claim 1, wherein the feed device comprises a pneumatic feed tube for transferring product from the auxiliary container to a buffer reservoir, the buffer reservoir transferring product to the third transfer chamber at a rate sufficient to maintain a minimum fill level of the third transfer chamber.

12. The apparatus of claim 11, wherein the buffer reservoir comprises a housing disposed above the third transfer chamber having at least one pneumatic exhaust port at a selected fill level, wherein when product in the buffer reservoir reaches the fill level, the at least one pneumatic exhaust port is obstructed by the product such that airflow through the pneumatic feed tube is reduced and entrainment of the product is stopped.

13. The apparatus of claim 12, wherein the housing is in the form of an upright cylinder.

14. The apparatus of claim 1, wherein the third transfer chamber is disposed longitudinally between the first and second transfer chambers.

15. The apparatus of claim 1, wherein the third metering assembly is disposed longitudinally between the first and second containers.

16. The apparatus of claim 1, wherein the first, second, and third metering assemblies are identical.

17. The apparatus of claim 1, wherein each of the first, second, and third metering devices comprises an inclined auger.

18. The apparatus of claim 1, wherein the plurality of distribution tubes includes a quantity of upper tubes spaced laterally apart in an upper layer and a quantity of lower tubes spaced laterally apart in a lower layer disposed beneath the upper layer.

19. The apparatus of claim 18, wherein the quantity of upper tubes is in the range of 5 to 12, and the quantity of lower tubes is in the range of 5 to 12.

20. The apparatus of claim 18, wherein the quantity of upper tubes is equal to the quantity of lower tubes.
